(19) United States
(12) Patent Application Publication
(10) Pub. No.: US 2007/0286713 A1
(43) Pub. Date: Dec. 13, 2007

(54) Tire dolly assembly

(75) Inventor: Edward J. Giese, Streamwood, IL (US)

Correspondence Address: Meroni & Meroni, P.C., P.O. Box 309, Barrington, IL, 60011, US

(73) Assignee: TRID Industries, Inc.

(21) Appl. No.: 11/449,238

(22) Filed: Jun. 8, 2006

(51) Int. Cl. B60B 29/00

(52) U.S. Cl. 414/427

(57) ABSTRACT

A dolly assembly rotatably supports and enables roller positioned placement of a tire. The dolly assembly comprises three C-shaped frames, two roller assemblies, and wheel assemblies. The C-shaped members each comprise opposing support arms and a framing span. The roller assemblies each comprise an inner support span and a cylindrical roller member. The cylindrical roller members are rotatable about the inner support span axes. The inner support span joins the support arms of the first and second C-shaped members. The support arms of the first and second C-shaped members are adjustably mounted to and supported by the support arms of the third C-shaped member. The roller assemblies function to rotatably support a tire. The wheel assemblies are cooperatively associated with the third C-shaped member for enabling roller movement relative thereto.

### BACKGROUND OF THE INVENTION

1. Field of the Invention

The present invention generally relates to a device for supporting and positioning a vehicular tire or wheel. More particularly, the present invention relates to a device for supporting and positioning a vehicular tire or wheel assembly to aid the user during wheel removal and/or installation on the axle-mounted hub of a vehicle.

2. Description of the Prior Art

As noted in U.S. Pat. No. 5,176,487, during the removal and installation of a vehicular tire or wheel assembly, the tire assembly must be momentarily elevated for alignment of the wheel lug openings with the threaded lugs on the axle mounted hub. Various tools and apparatus are disclosed in prior U.S. patents which are directed toward accomplishing this objective. Some of the more pertinent prior art patents relating to the subject matter of this disclosure are briefly described hereinafter.

U.S. Pat. No. 4,692,082 ('082 patent), which issued to Smith, discloses an Adjustable Dual-Wheel Caddy. The '082 patent teaches an adjustable dual-wheel caddy for supporting wheel assemblies when they are removed from vehicles is described. The caddy includes a U-shaped support having a single movable leg and rollers along the lower surfaces of both legs. A crank handle is provided to manually change the bight of the “U” only in response to rotation thereof. An internal rack is provided along at least a portion of the bight of said “U”. A spur gear is rotatably mounted on the movable leg in mesh with the rack and a worm gear is mounted on the crank handle to drive the spur gear in response to manual rotation.

U.S. Pat. No. 4,854,803 ('803 patent), which issued to Coccaro, discloses an Apparatus and Method for Jacking and Dollying an Affixed Vehicle Wheel Assembly. The '803 patent teaches an apparatus and method for jacking and dollying a vehicle wheel assembly, while the assembly remains affixed to the vehicle, the wheel assembly including a pneumatic tire, a wheel and an axle. The apparatus features a “U” shaped framework having telescoping body section members to which orthogonally extending arms are attached. Wheel assembly engaging elements in the form of roller assemblies are mounted on the framework arms for engaging the tire of a wheel assembly located therebetween for lifting. The apparatus also includes an actuator mounted on the framework body section members for driving the roller assemblies against the wheel assembly tire to cause lift, and form the framework and roller assemblies into a carriage for retaining the wheel assembly. Still further, the framework is mounted on casters to enable transport of the supported wheel assembly and framework. The actuator is preferably foot operated and includes a bidirectional, double pawl, lever ratchet mechanism having a lever pivotally mounted to one body section member together with a first and a second pawl, and a rack provided at the other body section member. The actuator also includes direction control elements having a first setting to enable the apparatus to lift the wheel assembly, and a second setting to enable the apparatus to lower the wheel assembly. The method features steps for driving a plurality of wheel engaging elements, at least one of which includes a roller assembly, against the tread face of the tire of the wheel assembly to be lifted by leveraging for a predetermine distance the coupling member of one wheel engaging element from a fulcrum located on the coupling member of another wheel engaging element, then bracing the coupling members against separation, and thereafter, resetting and re-leveraging to successively drive the wheel engaging elements against the wheel assembly to produce lift.

U.S. Pat. No. 5,112,070 ('070 patent), which issued to Hahn, discloses a Dual Wheel Puller Dolly. The '070 patent teaches a dual wheel puller/dolly comprising a pair of mobile elongated frame members with an elongated rod extending transversely therebetween and a jack mechanism cooperative with the rod. An elongated roller is rotatively mounted onto the top of each frame member to engage with a pair of large heavy motor vehicle wheels. When the jack mechanism is operated the large heavy wheels will be lifted upwardly to be moved about. One of the elongated frame members can also be used with other components, such as a pair of chains and a socket, as a wheel hub puller so as to facilitate the removal of a wheel bearing therefrom.

U.S. Pat. No. 5,176,487 ('487 patent), which issued to Flitton, discloses a Vehicle Wheel Changing Tool. The '487 patent teaches wheel changing apparatus comprising a pair of angular arms supported at their outer ends by caster wheels or skids with the arms joined at their remaining ends by a connector housing. A handle on the housing facilitates raising and lowering of the arms and a vehicle wheel assembly in place thereon for wheel assembly removal and attachment to an axle mounted hub. Multiple rollers in each arm rotatably support the wheel assembly. The arms are collapsible toward one another and the handle repositionable between the arms for compact stowage of the apparatus in a vehicle.

U.S. Pat. No. 5,702,226 ('226 patent), which issued to Pickle, discloses a Tire Dolly. The '226 patent relates to a tire dolly comprising a cross member which comprises a cross member axle. The cross member further comprises a cross member left tire securely mounted on a left distal end of the cross member axle by a cross member left axle cap and a cross member right tire securely mounted on a right distal end of the cross member axle by a cross member right axle cap. The tire dolly further comprises a left fork which comprises a left fork shaft securely mounted at an inner distal end onto the cross member. The left fork further comprises a left fork roller rotatably longitudinally disposed upon the left fork shaft. The left fork further comprises a left fork cap securely mounted at an outer distal end of the left fork shaft functioning to retain the left fork roller thereon. The tire dolly further comprises a right fork which comprises a right fork shaft securely mounted at an inner distal end onto the cross member. The right fork further comprises a right fork roller rotatably longitudinally disposed upon the right fork shaft. The right fork further comprises a right fork cap securely mounted at an outer distal end of the right fork shaft functioning to retain the right fork roller thereon. The tire dolly further comprises a handle securely mounted onto the cross member.

It will be seen from an inspection of the foregoing as well as from a general consideration of the state of the art that the prior art does not teach a tire dolly assembly comprising three II-shaped support frames or members, two of which may be oppositely and adjustably mounted to the arms of the third support frame and two further comprise roller means for rotatably supporting a tire that extend intermediate the opposing support arms. Thus, the prior art perceives a need for a tire dolly assembly comprising three II-shaped support frames or members of the type heretofore described insofar as the briefly set forth tire dolly assembly has certain advantages of the prior art dolly type apparatuses and devices disclosed in the prior art.

### SUMMARY OF THE INVENTION

Accordingly, it is a primary object of the present invention to provide a dolly assembly for rotatably supporting and roller positioning a tire or tire assembly. Structurally, the tire dolly assembly of the present invention comprises three II-shaped or C-shaped structures or members; first and second cylindrical roller assemblies, and certain castor type wheel assemblies or similar other roller means for omni-directional movement.

The II-shaped members each comprise first and second support arms and a framing span. The support arms each comprise an inner support arm end, an outer support arm end, and a support arm axis. The framing spans join the support arms at the outer support arm ends and each comprises a span axis. The first and second cylindrical roller assemblies each comprise an inner support span and a cylindrical roller member. The cylindrical roller members are rotatable about the inner support span axes.

The inner support span joins the support arms of the first and second II-shaped members at the inner support arm ends. The support arms of the first and second II-shaped members are adjustably mounted to and supported by the support arms of the third II-shaped member. The first and second cylindrical roller assemblies function to rotatably support a tire or wheel. The roller means for omni-directional movement are cooperatively associated with the third II-shaped member for enabling roller movement relative thereto. The tire dolly assembly is thus roller movable relative to a support surface and a tire is rotatable atop the roller assemblies about a tire axis of rotation.

Other objects of the present invention, as well as particular features, elements, and advantages thereof, will be elucidated or become apparent from, the following description and the accompanying drawing figures.

### BRIEF DESCRIPTION OF THE DRAWINGS

Other features of my invention will become more evident from a consideration of the following brief description of patent drawings:

FIG. 1 is a top perspective view of the preferred embodiment of the tire dolly assembly of the present invention with a vehicular tire shown in phantom as supported by the tire dolly assembly.

FIG. 2 is a top exploded perspective view of the preferred embodiment of the tire dolly assembly of the present invention.

FIG. 3 is a top perspective view of the preferred embodiment of the tire dolly assembly of the present invention with a vehicular tire shown in phantom as supported by the tire dolly assembly and an axle-mounted hub site of a vehicle, the tire dolly assembly positioning the tire adjacent the axle-mounted hub.

FIG. 4 is a side view of the preferred embodiment of the tire dolly assembly of the present invention with a vehicular tire shown in phantom as supported by the tire dolly assembly and a handle assembly shown in a propped position and a manually operable phantom position.

FIG. 5 is a fragmentary top perspective view of the junction intermediate a supported first II-shaped member and a supporting second II-shaped member depicting the adjustably mountable structural feature of the supported first II-shaped member.

### DETAILED DESCRIPTION OF THE PREFERRED EMBODIMENT(S)

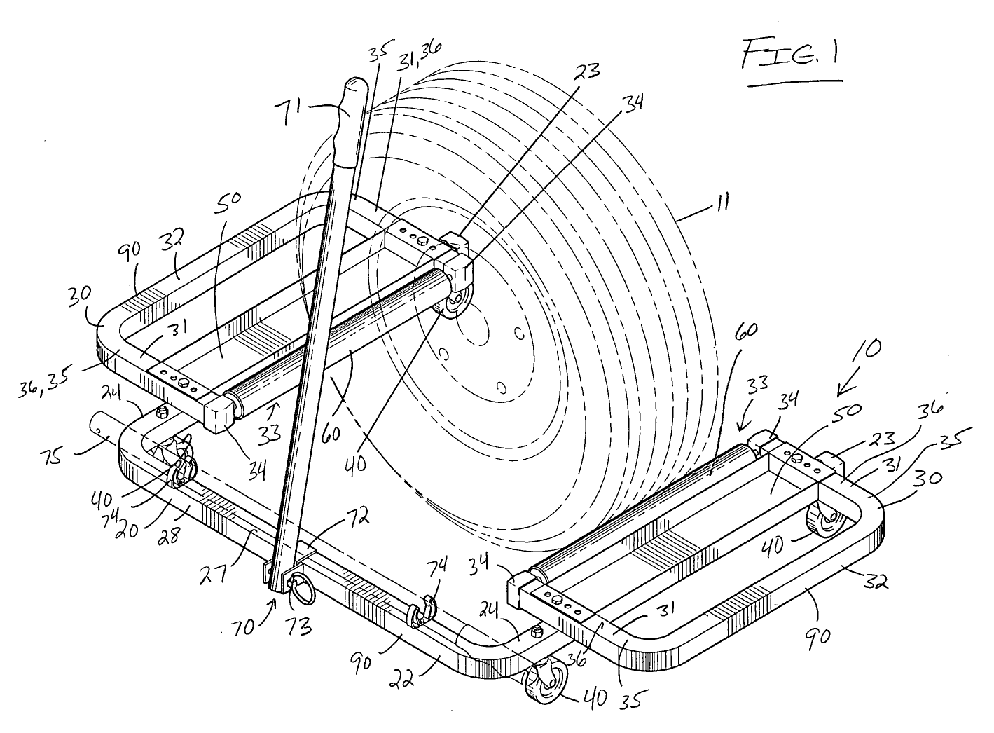

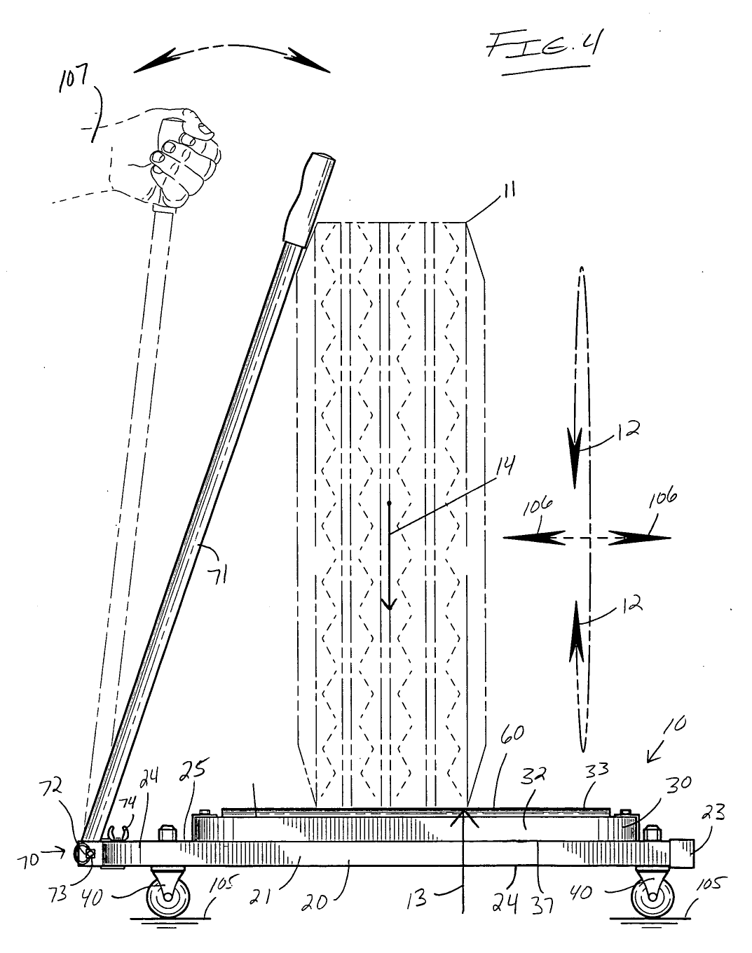

Referring now to the drawings, the preferred embodiment of the present invention concerns a tire dolly assembly 10 as generally illustrated and referenced in FIGS. 1-4. It is contemplated that tire dolly assembly 10 may effectively function to rotatably support a tire 11 as further illustrated in phantom and referenced in FIGS. 1, 3, and 4. Further, it is contemplated that tire dolly assembly 10 may effectively function to enable a user to roller position the rotatably supported tire 11. FIG. 4 depicts tire dolly assembly rotatably supporting tire 11. Certain clockwise and counterclockwise rotation is referenced at arrows 12 and certain support is referenced at arrow 13 (the weight of tire 11 being referenced at arrow 14).

To achieve these and other readily apparent functions, tire dolly assembly 10 preferably comprises a II-shaped (or roughly C-shaped) member 20 as illustrated and referenced in FIGS. 1-5; two (or first and second) roughly rectangular support assemblies 30 as illustrated and referenced in FIGS. 1-5; and certain roller means for movement as may be defined or bound by a number of structural configurations. The roller means for movement, may, for example, be preferably defined by castor type wheel assemblies 40 as illustrated and referenced in FIGS. 1-5. In this regard, the roller means for movement may be defined by certain roller means for omni-directional movement, as castor type wheel assemblies 40 may enable.

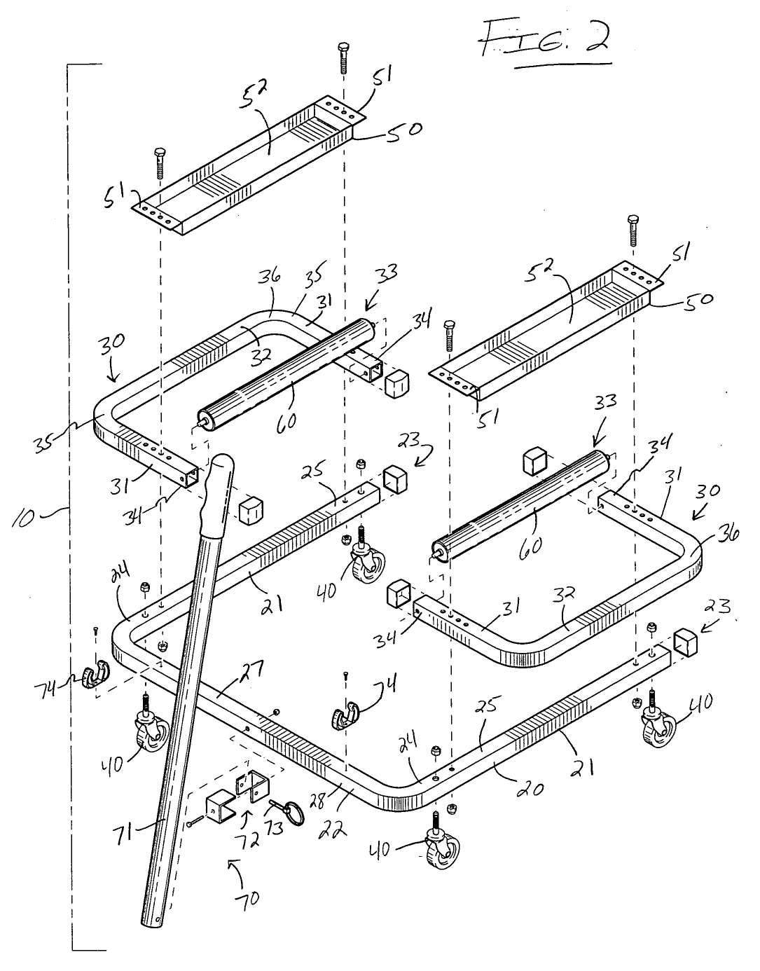

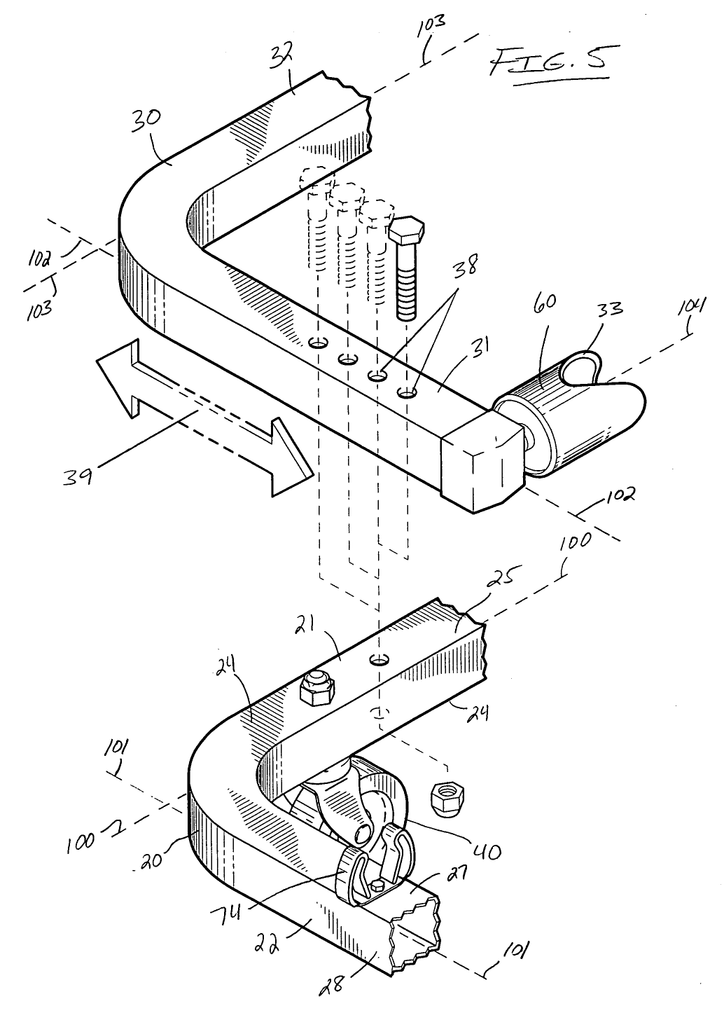

A II-shaped or C-shaped structure may be said to define an open, three-sided rectangular structure. In this regard, it will be noted that the II-shaped member 21 preferably comprises first and second framing arms 21 as illustrated and referenced in FIGS. 2, 4, and 5; and a framing span 22 as further illustrated and referenced in FIGS. 1-3, and 5. It will be seen from an inspection of the noted figures that framing arms 21 preferably have a uniform length and each comprise a free end 23 as referenced in FIGS. 1-4; a framing junction end 24 as referenced in FIGS. 1-5; a superior framing arm surface 25 as referenced in FIGS. 2, 4, and 5; an inferior framing arm surface 26 as referenced in FIGS. 4 and 5; and a framing arm axis 100 as referenced in FIG. 5. Being preferably integrally formed with framing arms 21, framing span 22 joins the framing arms 21 at the framing junction ends 24 and comprises a framing span length, a superior framing span surface 27 as referenced in FIGS. 1-3, and 5; an outer framing span surface 28 as referenced in FIGS. 1-3, and 5; and a framing span axis 101 as referenced in FIG. 5. It will be understood from a consideration of the drawings and foregoing descriptions that the framing arm axes 100 are preferably parallel to one another and orthogonal to the framing span axis 101.

Each support assembly 30 preferably comprises first and second support arms 31 as illustrated and referenced in FIGS. 1-3, and 5; an outer support span 32 as illustrated and referenced in FIGS. 1-5; and an inner support span as illustrated and referenced in FIGS. 1-5. The support arms preferably have a uniform length and each comprise an inner support junction end 34 as referenced in FIGS. 1 and 2; an outer support junction end 35 as referenced in FIGS. 1 and 2; a superior support arm surface 36 as referenced in FIGS. 1 and 2; an inferior support arm surface 37 as referenced in FIG. 4; and a support arm axis 102 as referenced in FIG. 5. Being preferably integrally formed therewith, the outer support spans 32 join the support arms 31 at the outer support junction ends 35 and have a uniform support span length, and a support span axis 103 as referenced in FIG. 5. The inner support spans 33 preferably join the support arms 31 at the inner support junction ends 34, but are not preferably formed therewith as set forth in more detail hereinafter. Preferably, the support arm axes 102 are parallel to one another and orthogonal to the outer support span axes 103 (and inner support span axes 104 as further referenced in FIG. 5).

The first and second support assemblies 30 are preferably mounted to the first and second framing arms 21 and supported at the superior framing arm surface 25. The framing arm axes 100 are thus preferably parallel with the support span axes 103 and 104, and the support arm axes 102 are preferably parallel with the framing span axis 101. The inner support spans 33 essentially function to support tire 11 (or similar other article) intermediate the support arms 31. It is contemplated that each support arm 31 may be outfitted with certain apertures 38 for enabling support assembly adjustment (to accommodate larger or smaller diameter tires, for example) as generally depicted in FIG. 5 at 39. Certain support assembly adjustment means are thus contemplated and may be defined by the apertures 38 in cooperative association with certain fastening means. Thus, the support assembly adjustment means may effectively function to enable a user to selectively adjust the distance intermediate the first and second support assemblies 30 relative to one another.

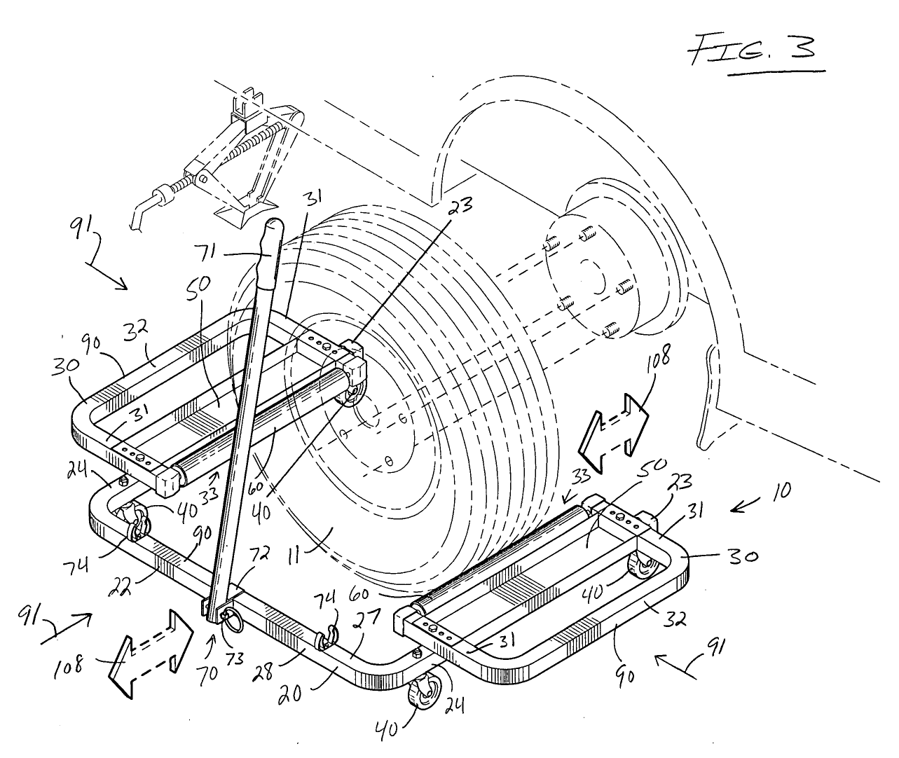

Certain roller means for movement, as introduced hereinabove, are preferably cooperatively associated with the inner support spans 33 and the inferior framing arm surface(s) 24 for enabling roller movement relative thereto. More specifically, when defined, in part, by castor type wheel assemblies 40, the roller means for movement may be located intermediate the inferior framing arm surface(s) and a support surface 105 (as referenced in FIG. 4) for enabling roller type movement intermediate tire dolly assembly 10 and support surface 105. Further, certain cylindrical rollers or cylindrical roller assemblies 60 (as referenced in FIGS. 1-5) may be cooperatively associated with the inner support spans 33 for enabling rotational movement about the inner support span axes 104. In other words, the roller means for movement cooperatively associated with the inner support spans 33 may be preferably defined by first and cylindrical roller assemblies 60, the first and second roller assemblies 60 being rotatably mounted to the inner support spans 33 and rotatable about the inner support span axes 104 for enabling clockwise and counterclockwise rotation of tire 11 about the tire axis of rotation 106. Thus, tire dolly assembly 10 is roller movable relative to support surface 105 and tire 11, as supported by inner support spans 33, is preferably rotatable about a tire axis of rotation as referenced at arrows 106 in FIG. 4. Tire dolly assembly 10, as preferably described, thus functions to (rotatably) support tire 11 and further enables a user 107 (as referenced in FIG. 4) to roller position tire 11 via the roller means for movement as generally and collectively depicted in FIGS. 3 and 4 at arrows 108.

It is contemplated that tire dolly assembly 10 may further comprise certain article-containing means, the article containing means being cooperatively associated with at least one of the support assemblies 30 or framing member 20 for corralling and supporting articles usable in combination with the tire. In this regard, it is contemplated that a pair of roughly rectangular open top containers 50 may preferably define the article-containing means and may be cooperatively associated with the support assemblies 30 for corralling and supporting articles usable in combination with tire (as, for example, mounting nuts, wrenches, or similar other hardware and/or tools). The open top containers 50 are illustrated and referenced in FIGS. 1-3. It will be seen from an inspection of the noted figures that containers 50 preferably extend intermediate the support arms 31 (and support spans 32 and 33). In this last regard, it will be seen that the preferred embodiment(s) of the containers 50 may comprise support flanges 51 and a container bottom 52 as specifically referenced in FIG. 2. Support flanges 51 are preferably supported by certain of the support arms 31 or certain selected support arms 31 and container bottoms 52 are preferably supported by certain of the framing arms 21 as rested atop the superior framing arm surface(s) 25.

Tire dolly assembly 10 may further comprise certain dolly-handling means for enabling a user to manually (i.e. with one's hand) effect movement of the tire dolly assembly 10 as generally depicted in FIG. 4. The dolly-handing means may take the form of a handle assembly 70 as generally illustrated and referenced in FIGS. 1-4. Handle assembly 70 may preferably comprise an elongate handle member 71 as further referenced in the noted figures, and certain span-attaching means. The span attaching means preferably have a pivot axis and function to attach the handle member 71 to the framing span 22 intermediate the framing span length as generally depicted in FIGS. 1-3. The span attaching means may be preferably defined by a certain bracket assembly 72 as generically referenced in FIGS. 1-4, and a pin 73 cooperatively associable with the bracket assembly 72 and the inferior end of the handle member 71 for pivotally connecting the handle member 71 to the framing span 22.

The handle member 71 is thus pivotable about the pivot axis (extending through pin 73), which pivot axis preferably extends parallel to the framing span axis 101 adjacent the outer span surface 28. In order to allow for selective stowage of the handle member 71, it is contemplated that tire dolly assembly 10 may further comprise certain handle-stowing means, which handle-stowing means may be cooperatively associated with the superior framing span surface 27 of the framing span 22, but alternatively with another of the support spans 32, and in this regard, it is contemplated that the handle-stowing means may be associated with a select support span for selectively stowing the handle member. The handle-stowing means may be preferably defined by laterally-opposed flexibly resilient C-shaped brackets 74 for selectively stowing the handle member 71 substantially as shown or depicted in FIG. 1 at 75 (i.e. the handle member 71 shown in phantom in stowed position). Brackets 74 are further illustrated and referenced in FIGS. 1-5. Thus, the handle-stowing means enable selective stowage of handle member 71.

It will thus be seen that the present invention discloses a tire dolly assembly for rotatably supporting and roller positioning a tire, which tire dolly assembly may be said to comprise first, second, and third II-shaped members. The first and second II-shaped members may be defined by the support arms 31 and the support spans 32 of respective support assemblies 30. When first and second cylindrical roller assemblies 60 connect the inner support arm ends 34 of first and second support arms, support assemblies 30 may be said to be the structural result.

Thus, the II-shaped members each comprise first and second support arms (as may be defined by support arms 31 and framing arms 21) and a framing span (as may be defined by outer support spans 32 and framing span 22). The support arms each comprise an inner support arm end, an outer support arm end, and a support arm axis. The framing spans join the support arms at the outer support arm ends and each comprises a span axis. The first and second cylindrical roller assemblies each comprise an inner support span and a cylindrical roller member. The cylindrical roller members are rotatable about the inner support span axes.

The inner support span joins the support arms of the first and second II-shaped members at the inner support arm ends and the support arms of the first and second II-shaped members are preferably adjustably mounted to and supported by the support arms of the third II-shaped member. The first and second cylindrical roller assemblies thus function to rotatably support a tire. Certain roller means for omni-directional movement are cooperatively associated with the third II-shaped member for enabling roller movement relative thereto. The tire dolly assembly of the present invention is thus roller movable relative to a support surface and the tire is rotatable about a tire axis of rotation as supported by the roller assemblies. The tire dolly assembly thus function to rotatably support and roller position the tire.

While the above description contains much specificity, this specificity should not be construed as limitations on the scope of the invention, but rather as an exemplification of the invention. For example, as is described hereinabove, it is contemplated that the present invention essentially discloses a tire or article-supporting dolly assembly for supporting and roller positioning an article. It is contemplated that the dolly assembly essentially comprises first, second, and third II-shaped members, first and second support assemblies, and roller means for movement, the II-shaped members each comprising first and second support arms and an outer support span. The support arms extend outwardly (or inwardly) from the support span (spatially oriented outwardly).

The support assemblies may be said to essentially comprise an inner support span, the inner support spans extending intermediate the support arms of the first and second II-shaped members for supporting an article thereupon. The support arms of the first and second II-shaped members are preferably adjustably mounted to the support arms of the third II-shaped member, and the roller means for movement are cooperatively associated with the third II-shaped member for enabling roller movement relative thereto. The dolly assembly is thus roller movable relative to a support surface for supporting and roller positioning the article.

The support assemblies may comprise certain roller means for movement (as, for example, the cylindrical rollers of roller assemblies 60). The roller means for movement may be cooperatively associated with the inner support spans for rotatably supporting the article thereupon, which article may preferably comprise a circular transverse cross-section, and which article may be defined by a tire, wheel, sphere, or similar other article having an article axis of rotation.

Further, the dolly assembly may comprise certain containment means (as, for example, article-containing means earlier described), the containment means being cooperatively associated with at least one select II-shaped member for containing matter usable in connection with the article.

It is contemplated, as a further example, that the dolly-handing means may take the form of a series of peripheral dolly handles 90 as defined by the framing span 22 and the outer support spans 32, the peripheral dolly handles for enabling a user to grasp the tire dolly assembly 10 from a plurality of directions as generically referenced at arrows 91 in FIG. 3.

Accordingly, although the invention has been described by reference to certain preferred embodiments and methodology, it is not intended that the novel disclosures herein presented be limited thereby, but that modifications thereof are intended to be included as falling within the broad scope and spirit of the foregoing disclosure, the following claims and the appended drawings.

I claim:

1. A tire dolly assembly, the tire dolly assembly for supporting a tire and enabling a user to roller position the supported tire, the tire dolly assembly comprising:
a II-shaped member, first and second support assemblies, and roller means for movement, the II-shaped member comprising first and second framing arms and an framing span, the framing arms having a uniform length and each comprising a free end, a framing junction end, a superior framing arm surface, an inferior framing arm surface, and a framing arm axis, the framing span joining the framing arms at the framing junction ends and comprising a framing span length, a superior framing span surface, an outer framing span surface, and a framing span axis, the framing arm axes being parallel to one another and orthogonal to the framing span axis, each support assembly comprising first and second support arms, an outer support span, and an inner support span, the support arms having a uniform length and each comprising an inner support junction end, an outer support junction end, a superior support arm surface, and a support arm axis, the support spans joining the support arms at the support junction ends and having a uniform support span length and a support span axis, the support arm axes being parallel to one another and orthogonal to the support span axes, the first and second support assemblies being mounted to the first and second framing arms at the superior framing arm surface, the framing arm axes being parallel with the support span axes, the inner support spans for supporting a tire intermediate the support arms, the roller means for movement being cooperatively associated with the inner support spans and the inferior framing arm surfaces for enabling roller movement relative thereto, the tire dolly assembly thus being roller movable relative to a support surface and the tire being rotatable about a tire axis of rotation, the tire dolly assembly thus for supporting the tire and enabling a user to roller position the tire via the roller means for movement.

2. The tire dolly assembly of claim 1 comprising a pair of rectangular open top containers, the rectangular open top containers for corralling and supporting articles usable in combination with the tire, the rectangular open top containers extending intermediate the support arms.

3. The tire dolly assembly of claim 2 wherein the rectangular open top containers comprise support flanges and a container bottom, the support flanges being supported by the support arms and the container bottoms being supported by the framing arms.

4. The tire dolly assembly of claim 1 wherein the roller means for movement cooperatively associated with the inner support spans are defined by first and second roller assemblies, the first and second roller assemblies being rotatably mounted to the inner support spans and rotatable about the inner support span axes for enabling clockwise and counterclockwise rotation of the tire about the tire axis of rotation.

5. The tire dolly assembly of claim 1 comprising a handle assembly, the handle assembly comprising an elongate handle member and a span-attaching means, the span attaching means attaching the handle member to the framing span intermediate the framing span length, the handle member being pivotable about a pivot axis, the pivot axis extending parallel to the framing span axis.

6. The tire dolly assembly of claim 5 comprising handle-stowing means, the handle stowing means being cooperatively associated with the framing span for selectively stowing the handle member when detached from the framing span.

7. The tire dolly assembly of claim 1 wherein the framing span and the outer support spans define a series of peripheral dolly handles, the peripheral dolly handles for enabling a user to grasp the tire dolly assembly from a plurality of directions.

8. The tire dolly assembly of claim 1 comprising support assembly adjustment means, the support assembly adjustment means for enabling a user to selectively adjust the distance intermediate the first and second support assemblies relative to one another for accommodating tires of varying diameters.

9. A tire dolly assembly, the tire dolly assembly for rotatably supporting and roller positioning a tire, the tire dolly assembly comprising:
first, second, and third II-shaped members, first and second cylindrical roller assemblies, and roller means for omni-directional movement, the II-shaped members each comprising first and second support arms and a framing span, the support arms each comprising an inner support arm end, an outer support arm end, and a support arm axis, the framing spans joining the support arms at the outer support arm ends and each comprising a span axis, the first and second roller assemblies each comprising an inner support span and a cylindrical roller member, the inner support span having a support span axis, the cylindrical roller members being rotatable about the inner support span axes, the inner support span joining the support arms of the first and second II-shaped members at the inner support arm ends, the support arms of the first and second II-shaped members being mounted to and supported by the support arms of the third II-shaped member, the first and second roller assemblies for rotatably supporting a tire, the roller means for omni-directional movement being cooperatively associated with the third II-shaped member for enabling roller movement relative thereto, the tire dolly assembly thus being roller movable relative to a support surface and the tire being rotatable about a tire axis of rotation, the tire dolly assembly thus for rotatably supporting and roller positioning the tire.

10. The tire dolly assembly of claim 9 comprising article-containing means, the article containing means being cooperatively associated with at least one select II-shaped member for corralling and supporting articles usable in combination with the tire.

11. The tire dolly assembly of claim 9 comprising dolly-handling means, the dolly handling means for enabling a user to manually effect movement of the tire dolly assembly.

12. The tire dolly assembly of claim 11 wherein the dolly-handling means comprises a handle assembly, the handle assembly comprising an elongate handle member and a span-attaching means, the span attaching means attaching the handle member to a first select support span.

13. The tire dolly assembly of claim 12 comprising handle-stowing means, the handle stowing means being cooperatively associated with a second select support span for selectively stowing the handle member.

14. The tire dolly assembly of claim 11 wherein the dolly-handling means are defined by the support spans, the support spans defining a series of peripheral dolly handles, the peripheral dolly handles for enabling a user to grasp the tire dolly assembly from a plurality of directions.

15. The tire dolly assembly of claim 9 comprising support assembly adjustment means, the adjustment means for enabling a user to selectively adjust the distance intermediate the first and second II-shaped members.

16. A dolly assembly, the dolly assembly for supporting and roller positioning an article, the dolly assembly comprising:
first, second, and third II-shaped members, first and second support assemblies, and roller means for movement, the II-shaped members each comprising first and second support arms and an outer support span, the support arms extending inwardly from the outer support span, the support assemblies each comprising an inner support span, the inner support spans extending intermediate the support arms of the first and second II-shaped members for supporting an article thereupon, the support arms of the first and second II-shaped members being mounted to the support arms of the third II-shaped member, the roller means for movement being cooperatively associated with the third II-shaped member for enabling roller movement relative thereto, the dolly assembly thus being roller movable relative to a support surface, the dolly assembly thus for supporting and roller positioning the article.

17. The dolly assembly of claim 16 wherein the support assemblies comprise roller means for movement, the roller means for movement being further associated with the inner support spans for rotatably supporting the article thereupon, the article comprising a circular transverse cross-section, the article being rotatable about an article axis of rotation, the dolly assembly thus for rotatably supporting and roller positioning the article.

18. The dolly assembly of claim 16 comprising containment means, the containment means being cooperatively associated with at least one select II-shaped member for containing matter usable in connection with the article.

19. The dolly assembly of claim 16 comprising dolly-handling means, the dolly handling means for enabling a user to manually effect movement of the dolly assembly.

20. The tire dolly assembly of claim 16 comprising support assembly adjustment means, the adjustment means for enabling a user to selectively adjust the distance intermediate the first and second II-shaped members.
